(19) United States
(12) Patent Application Publication
(10) Pub. No.: US 2020/0265095 A1
(43) Pub. Date: Aug. 20, 2020

(54) SYSTEM THAT CUSTOMIZES A RE-RANKER BASED UPON END USER INPUT

(71) Applicant: Microsoft Technology Licensing, LLC, Redmond, WA (US)

(72) Inventors: Kalpesh BHIMANI, Bothell, WA (US); Ashwin Mallur PARTHASARATHY, Bellevue, WA (US); Yumao LU, Bellevue, WA (US); Victor Hugo Onate ACOSTA, Redmond, WA (US); Tony Ducheng JIN, Seattle, WA (US); Tong Yuzhe LIU, Seattle, WA (US)

(21) Appl. No.: 16/281,060

(22) Filed: Feb. 20, 2019

(51) Int. Cl. G06F 16/903; G06F 16/909; G06F 16/904; G06F 16/9038

(52) U.S. Cl. CPC G06F 16/90335; G06F 16/9038; G06F 16/904; G06F 16/909

(57) ABSTRACT

A search system is described herein. The search system is configured to search over several different catalogs, where each catalog includes entries that represent goods and/or services offered for acquisition by companies. The search system receives a query and outputs search results from a catalog based upon the query. The search system includes a general-purpose ranker that is configured to receive the search results and rank the search results, thereby generating a ranked list of search results. The general-purpose ranker is used to rank the search results regardless of the catalog from which the search results were retrieved. The search system further includes a re-ranker that is customized for the catalog, wherein the re-ranker receives the ranked list of search results and re-ranks such search results, thereby generating a second ranked list of search results.

### BACKGROUND

Computer-implemented search engines are configured to return ranked lists of search results to client computing devices responsive to receiving queries from the client computing devices. To provide relevant search results, the computer-implemented search engines infer the information retrieval intent of the users who submitted the queries. Inferring an information retrieval intent of end users has proven to be a difficult task, at least partially because end users often submit ambiguous queries to computer-implemented search engines. For instance, a user may be interested in acquiring information about televisions and may set forth the query “television” to a computer-implemented search engine. The query “television”, however, does not specify a size of the television that is of interest to the user, does not specify technical features of the television that are of interest to the user (e.g., LED, OLED, LCD, etc.). Further, the query “television”, without additional context, is ambiguous as to whether the issuer of the query is interested in acquiring information about television sets or television shows. Popular computer-implemented search engines have been developed over the course of several years to infer the information retrieval intent of users who issue queries to the search engines by taking into account historical queries of users, features of the queries, features of potential search results, amongst other information.

These computer-implemented search engines are the result of a massive amount of research and the allocation of a massive amount of resources over the course of decades by a relatively small number of relatively large companies. Conventionally, companies other than those who have spent years developing search engines that wish to offer search services over certain catalogs are not able to offer robust computer-implemented search engines, as many of these companies do not have the resources to do so. For instance, a retailer who specializes in sale of electronic equipment to the general public may not have resources to develop and maintain a search engine that is well suited for inferring intent of users who are searching for certain types of electronic equipment. Conventionally, the retailer is left with two choices: 1) allocate resources to develop a customized search engine, which may nevertheless result in a sub-optimal end user experience for those attempting to search using such search engine; or 2) employ a general-purpose search engine offered by another company, where the general-purpose search engine is not customized for the business of the retailer and therefore may provide sub optimal search results to customers of the retailer who set forth queries.

In either of these approaches, the search engine employed by the company is somewhat inflexible. For instance, the company may wish to promote a new product such that it appears relatively high in a ranked list of search results when a user issues a query that includes the term “television”. In this example, the company must allocate resources to update its search engine to meet the above-described goal, which is often impractical. If the company employs the general-purpose search engine, there is no suitable mechanism that allows for the company to update how the search engine is to incorporate logic that is specific to the company.

### SUMMARY

The following is a brief summary of subject matter that is described in greater detail herein. This summary is not intended to be limiting as to the scope of the claims.

Described herein are various technologies pertaining to a computer-implemented search system that is configured to provide the robustness of a general-purpose search engine to a first company while also allowing for the first company to relatively easily customize operation of the search system. The search system includes a general-purpose ranker that, in an example, is developed and maintained by a second company that has dedicated resources over several years to search engine technology. The search system receives a query, searches over a catalog of the first company based upon the query, and outputs a set of search results from the catalog based upon the search. The general-purpose ranker is configured to receive the search results and rank the search results, thus creating a first ranked list of search results. The general-purpose ranker is not customized to search over the catalog.

The search system additionally includes a re-ranker that is customized for the first company. For instance, the re-ranker is based upon logic that the first company has set forth, wherein the logic indicates how search results are to be re-ranked. Continuing with the example set forth above, the first company may be a retailer who specializes in the sale of electronic equipment and may have a television in inventory that the first company wishes to promote (e.g., over other televisions in inventory). The re-ranker can be configured to boost a search result that represents the television when a query that includes the term “television” is received from an end-user. The re-ranker receives the first ranked list of search results from the general-purpose ranker and re-ranks such search results, thereby outputting a second ranked list of search results. Again, the re-ranker is customized for the first company based upon logic provided by the first company. Accordingly, the search system includes a general-purpose ranker that is developed and maintained by the second company, which has expertise in inferring user intent, and further includes a re-ranker that is customized for the first company.

The search system referenced above is well suited to allow for multiple different companies to leverage the advantages referenced above. Thus, the general-purpose ranker can be used by multiple companies offering goods and/or services for acquisition in multiple different industries, such that each of these companies can take advantage of the expertise of the second company that develops and maintains the general-purpose ranker. Moreover, each of the companies can generate one or more of its own custom re-rankers, such that ranked lists of search results output by the general-purpose ranker can be re-ranked as a function of the logic that is set forth by the companies.

There are various advantages to the approach described above. First, companies are able to leverage the general-purpose ranker, which has been developed and maintained by the second company. This results in more relevant search results being provided to issuers of queries when compared to search results provided when companies (who are unable to allocate sufficient resources to generate a robust ranker) attempt to implement their own search and ranking systems. In addition, companies are able to define customized re-rankers, which are based upon logic set forth by the companies. This provides greater flexibility to companies, as the companies can relatively easily generate new re-rankers or update existing re-rankers. Further, the companies can define situations where the re-rankers are to be employed (such as when a query is received within a certain time window, when a query is received from a certain geographic location, etc.).

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates generating a ranked list of search results based upon a received query.

FIG. 2 is a communications diagram illustrating communications between a client computing device, a host server system, and a search system in connection with provision of a ranked list of search results to the client computing device based upon a query set forth by an end user of the client computing device.

FIG. 3 illustrates an exemplary query.

FIG. 4 is a functional block diagram of an exemplary system that facilitates creation of a re-ranker that is configured to re-rank a ranked list of search results output by a general-purpose ranker.

FIG. 5 depicts an exemplary graphical user interface that is configured to receive input that is usable to create a re-ranker.

FIG. 6 is a flow diagram illustrating an exemplary methodology for transmitting a ranked list of search results to a host computing system based upon a query received from the host computing system.

FIG. 7 is a flow diagram illustrating an exemplary methodology for creating and/or updating a re-ranker.

FIG. 8 is a flow diagram illustrating an exemplary methodology for generating a re-ranker.

FIG. 9 is an exemplary computing system.

### DETAILED DESCRIPTION

Various technologies pertaining to a search system that is well-suited to output ranked lists of search results based upon logic that is set forth by companies are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component, system, or module may be localized on a single device or distributed across several devices. Further, as used herein, the term “exemplary” is intended to mean serving as an illustration or example of something and is not intended to indicate a preference.

Various technologies pertaining to a search system that includes: 1) a general-purpose ranker that outputs a ranked list of search results based upon a query; and 2) a re-ranker that receives the ranked list of search results and re-ranks such search results to generate a second ranked list of search results are described herein. The technologies described herein are particularly advantageous for companies who are offering goods and/or services for acquisition, wherein such companies are not well-equipped to allocate resources to develop and maintain search systems that are customized for the needs of the companies.

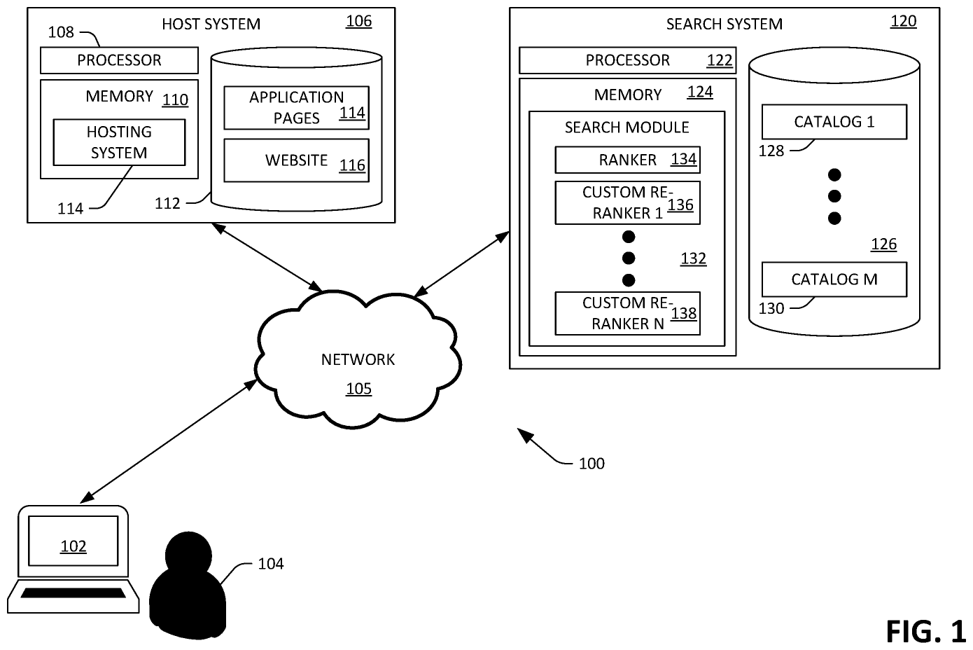

With reference now to FIG. 1, an exemplary system 100 that facilitates provision of a ranked list of search results to a user who sets forth a query is illustrated. The system 100 includes a client computing device 102 operated by a user 104. The client computing device 102 may be any suitable computing device, including but not limited to a desktop computing device, a laptop computing device, a tablet computing device, a mobile telephone; a wearable computing device, or the like. The system 100 additionally includes a host server system 106 that is in communication with the client computing device 104 by way of a network 105. The host server system 106 is configured to host an application or website of a company, wherein the company offers goods and/or services for acquisition to the user 104 by way of the application and/or the website. The host system 106 includes a processor 108, memory 110, and a data store 112, The memory 110 includes instructions that are executed by the processor 108. In the exemplary system 100 illustrated in FIG. 1 the memory 110 includes a hosting system 114 that is configured to serve webpages and/or application content to the client computing device 102 upon receipt of a request for such webpages and/or application content from the client computing device 102. When the hosting system 114 hosts an application, the data store 112 includes application pages 116 of the application. When the hosting system 114 hosts a website, the data store 112 includes webpages 118 of the website.

The system 100 also includes a search system 120 that is in communication with the host system 106 by way of the network 105. The search system 120 can comprise a server computing device, a data center, a portion of a data center, a rack of server computing devices, etc. The search system 120 is generally configured to: 1) receive a query; 2) search a catalog based upon the query, wherein the catalog includes entries that are representative of goods and/or services that are available for acquisition from a company; and 3) and output a ranked list of search results based upon the query.

The search system 120 includes a processor 122, memory 124, and a data store 126. The data store 126 includes a plurality of catalogs 128-130, wherein each of the catalogs 128-130 can be an electronic catalog of goods and/or services that are available for acquisition, and further wherein each of the catalogs is for a different company. Thus, the first catalog 128 is an electronic catalog of goods and/or services available for acquisition from a first company and the Mth catalog 130 is an electronic catalog of goods and/or services available for acquisition from an Mth company. The memory 124 includes a search module 132, wherein the search module 132 is configured to receive queries from host systems (which host websites and/or applications for different companies) and provide ranked lists of search results back to the host systems based upon the received queries.

The search module 132 includes a general-purpose ranker 134 (hereinafter referred to as ranker 134). The ranker 134 can be developed and maintained by an entity with expertise in information retrieval, such as an entity who has developed a general-purpose search engine for information retrieval. The memory 132 may also have a plurality of custom re-rankers 136-138 loaded therein. Companies that leverage the search system 120 to provide ranked lists of search results to end users can define one or more customized re-rankers in the re-rankers 136-138, where in each re-ranker is customized for a company that defines the re-ranker. Further, a company may define several different re-rankers. For instance, the company may define a first re-ranker that is to be employed by the search module 132 when a query is submitted from a first geographic location, and the company may define a second re-ranker that is to be employed by the search module 134 when a query is submitted from a second geographic location. Each customized re-ranker in the re-rankers 136-138 is configured to receive a ranked list of search results output by the ranker 134 and re-rank such ranked list of search results to generate a second ranked list of search results. The search module 132 is then configured to return the second ranked list of search results to the host system from which a query is received.

Operation of the system 100 is now described. The client computing device 102 receives a request from the user 104 to load a webpage of a company and/or the client computing device 102 receives a request from the user 104 to load content of an application (such as a mobile application that can be downloaded and installed from a mobile application store). The client computing device 102 transmits the request to the host system 106 that hosts the requested webpage and/or the requested application content. The host system 106, responsive to receiving such request, transmits the requested webpage and/or application content to the client computing device 102 by way of the network 105.

The client computing device 102 subsequently receives a query set forth by the user 104, wherein a catalog of goods and/or services that are offered for acquisition by the company is to be searched based upon the query. The client computing device 102 transmits the query to the host system 106 by way of the network 105. The query transmitted by the client computing device 102 to the host system 106 can include natural language set forth by the user 104, a timestamp that indicates when the client computing device 102 transmitted the query to the host system 106, location data that is indicative of a geographic location of the client computing device 102, etc. The query can optionally include other information pertaining to the client computing device 102, such as an IP address of the client computing device 102, information in cookies stored on the client computing device 102, and so forth.

The host system 106 receives the query, whereupon the query is provided to the hosting system 114. The hosting system 114 updates the query to include an identifier for the company, which may be a URL of the website of the company hosted by the host system 106, an identifier of the application of the company hosted by the host system 106, etc. The host system 106 transmits the updated query to the search system 120.

The search system 120 receives the (updated) query, whereupon the query is provided to the search module 132. The search module 132 identifies a catalog from amongst the catalogs 128-130 based upon the identifier for the company that is included in the query. In an example, based upon the identifier for the company, the search module 132 can determine that the first catalog 128 is to be searched over based upon the query. The search module 132, responsive to identifying the first catalog 128, utilizes any suitable search technology to generate search results that are relevant to the query. As indicated previously, the first catalog 128 can include values that are indicative of attributes of goods and/or services that are available for acquisition from the company, wherein such attributes can include name of a good or service, brand of the good or service, price of the good or service, level of inventory of the good at the company, etc. In a more specific example, if the company offers electronics for purchase, the first catalog 128 can include names of the electronics, manufacturers of the electronics, and attributes of the electronics such as processor speed, amount of memory, user reviews, and so forth.

Responsive to the search module 132 searching the first catalog 128 and generating the search results based upon the query, the ranker 134 ranks the search results to generate a first ranked list of search results. The ranker can rank the search results based upon features of the query (e.g., keywords in the query, time that the query was submitted, geographic location from which the query was submitted) and features of the search results (wherein each search result represents a good or service represented in the first catalog 128). As indicated previously, the ranker 134 is a general-purpose ranker, such that the ranker 134 is employed by the search module 132 to rank search results regardless of the catalog from amongst the catalogs 128-130 from which the search module 132 returns the search results.

In addition, based upon the identifier of the company in the received query, the search module 132 selects a re-ranker from amongst the customized re-rankers 136-138, wherein the re-ranker is selected to re-rank the first ranked list of search results output by the ranker 134. Additionally, the search module 132 can select the re-ranker based upon other features, such as (but not limited to) a timestamp assigned to the query (which indicates a time when the client computing device 102 transmitted the query to the host system 106), a geographic location assigned to the query (which indicates a geographic location of the user 104 when the user set forth the query to the client computing device 102), a keyword in the query, a webpage being presented at the client computing device 102 when the query was received, etc. For instance, the company may have defined several customized re-rankers, wherein the company may wish for a particular re-ranker to be used to re-rank search results based upon time of day (e.g., the company may have a flash sale for a particular item or set of items and may wish to boost such items in rankings), a geographic location (the company may wish to promote a first item in one geographic location while wishing to promote a second item in a second geographic location), etc. In another exemplary embodiment, the search module 132 may select a re-ranker from amongst the customized re-rankers 136-138 based upon content of the first catalog 128. For instance, when the search results returned by the search module 132 include an item that is indicated as having a very low inventory, the company may desire that a re-ranker be selected that is configured to boost low inventory items (thereby clearing items of companies that have relatively low inventory).

In an example, based upon the identifier of the company, a feature of the query, and/or a feature of the first catalog 128, the search module 132 can select the first customized re-ranker 136 from amongst the plurality of customized re-rankers 136-138. The first customized re-ranker is provided with the ranked list of search results output by the ranker 134. Responsive to receiving the ranked list of search results output by the ranker 134, the first customized re-ranker 136 generates a second ranked list of search results, wherein the second ranked list of search results is a re-ranking of the ranked list of search results. Responsive to the first customized re-ranker 136 outputting the second ranked list of search results (which represent a ranked list of products and/or services offered for acquisition by the company), the search module 132 causes the search system 122 transmit the second ranked list of search results to the host system 106 by way of the network 105. The host system 106 provides the hosting system 114 with the second ranked list of search results, and the hosting system 114 incorporates the second ranked list of search results into an application page or webpage. The host system 106 then transmits the application page or webpage (with the second ranked list of search results incorporated therein) to the client computing device 102 for review by the user 104.

From the perspective of the user 104, the workflow of the user 104 when searching for goods or services from an electronic company catalog is unchanged—the user initiates an application or requests a webpage of the company at the client computing device 102 and submits a query, which is transmitted to the host system 106. The host system 106, rather than searching a catalog itself and returning a ranked list of search results to the client computing device 102, transmits the query to the search system 120 (hence, the host system 106 has offloaded searching of the catalog of the company to the search system 120). The search system 120, as described above, employs the ranker 134 that is used to generate a ranked list of search results regardless of the identity of the hosting system 114 from which the query is received and further regardless of the catalog being searched over by the search module 132. The customized re-rankers 136-138 allow for incorporation of company-specific logic into the search pipeline; for example, if two different companies have the exact same catalog, the two different companies may define different customized re-rankers, resulting in possible presentment of different ranked lists of search results to two end users who submitted identical queries for use when searching over the catalog.

While FIG. 1 illustrates an exemplary architecture of the search module 132 and the search system 120, other architectures are contemplated. For instance, the system 100 has been described such that the search module 132 is able to conduct searches over the catalogs 128-130 as a function of an identity of a company included in a received query. In another exemplary architecture, a data center may include numerous devices, and numerous instances of the search module 132 can be executed across the devices, with each instance of the search module having access to only catalog(s) of a single company. In such an embodiment, the data center can route an incoming query to the appropriate instance of the search module 132 based upon the identifier of the company in the query. In another exemplary embodiment, the host system 106 can include a customized re-ranker. In such an exemplary embodiment, the host system 106 can transmit a query to the search system 120, whereupon the general-purpose ranker 134 outputs a ranked list of search results based upon the query. The search system 120 can transmit the ranked list of search results to the host system 106, which can employ the customized re-ranker to re-rank such ranked list of search results. Other exemplary architectures are also contemplated.

There are various advantages exhibited by the system 100 over conventional approaches for providing search results to end users. Specifically, the company is able to offload searching and an initial ranking to the search system 120, which may have expertise in inferring user intent based upon a received query. Hence, more relevant search results are provided to end-users when compared to conventional approaches where the company develops and maintains its own searching and ranking technologies. In addition, the system 100 incorporates, in the search pipeline, re-rankers that are customized for companies. These customized re-rankers allow for companies to set forth customized logic that is used to re-rank search results output by the general-purpose ranker 134.

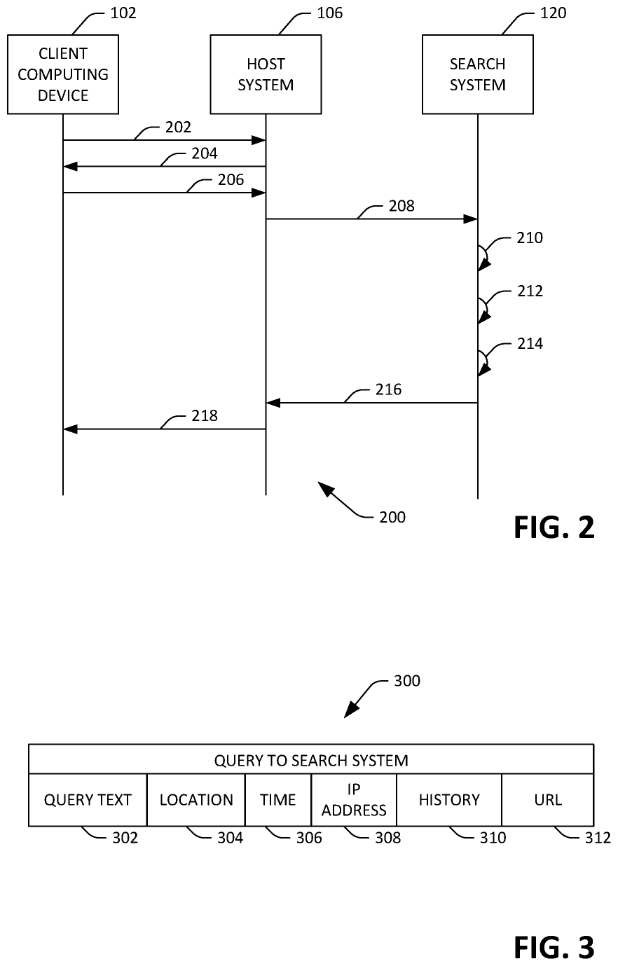

Referring now to FIG. 2, a communications diagram illustrating communications undertaken between the client computing device 102, the host system 106, and the search system 120 is illustrated. At 202, the client computing device 102 transmits a request for content to the host system 106. The request for content may be a request for a webpage of a website of a company, a request for application content from an application of the company, etc. At 204, the host system 106 transmits the requested content to the client computing device 102, whereupon the requested content is presented to the user 104. The client computing device 102 then receives a query from the user 104 as to a good and/or service offered by a company associated with the host system 106. The client computing device 102 can update the query to include one or more features, such as a timestamp, a geographic location, etc. and at 206 the client computing device 102 transmits the updated query to the host system 106.

Upon receiving the query, the host system 106 can further update the query to include data that identifies the company (e.g., such as a URL of a website hosted by the host system 106). At 208 the updated query is transmitted to the search system 120. At 210, the search system 120, based upon the data that identifies the company, identifies a catalog that is to be searched using the query. At 212, the search system 120, based upon a feature of the query and/or a feature of the catalog, identifies a custom re-ranker that is to be employed when providing search results back to the client computing device 102. At 214, the search system 120 searches the identified catalog based upon the query to generate search results, employs the generalized ranker 134 to rank the search results (thereby generating a ranked list of search results), and thereafter employs the identified customized re-ranker to re-rank the ranked list of search results to generate a second ranked list of search results.

At 216, the second ranked list of search results is transmitted to the host system 106, and at 218 the second ranked list of search results is transmitted to the client computing device 102. The client computing device 102 may then display the second ranked list of search results to the user 104.

With reference to FIG. 3, an exemplary query 300 that can be provided to the search system 120 from the host system 106 is illustrated. The query 300 can include a first field 302 that comprises query text (e.g., natural language set forth by the user 104). The query 300 may include a second field 304 that comprises data that is indicative of a location of the client computing device 102 that submitted the query to the host system 106.

The query 300 may further include a third field 306 that comprises a timestamp that is indicative of a time that the client computing device 102 transmitted the query to the host system 106. The query 300 may also include a fourth field 308 that comprises an IP address of the client computing device 102. A fifth field 310 may include history information that may be used by the general-purpose ranker 134 and/or the identified customized re-ranker when ranking search results. The history information may include webpages previously viewed by the user 104, identities of goods and/or services previously purchased by the user 104, natural language queries previously received from the client computing device 102, etc. The query 300 may further include a sixth field 312 that comprises an identifier of the host system 106 (e.g., a URL).

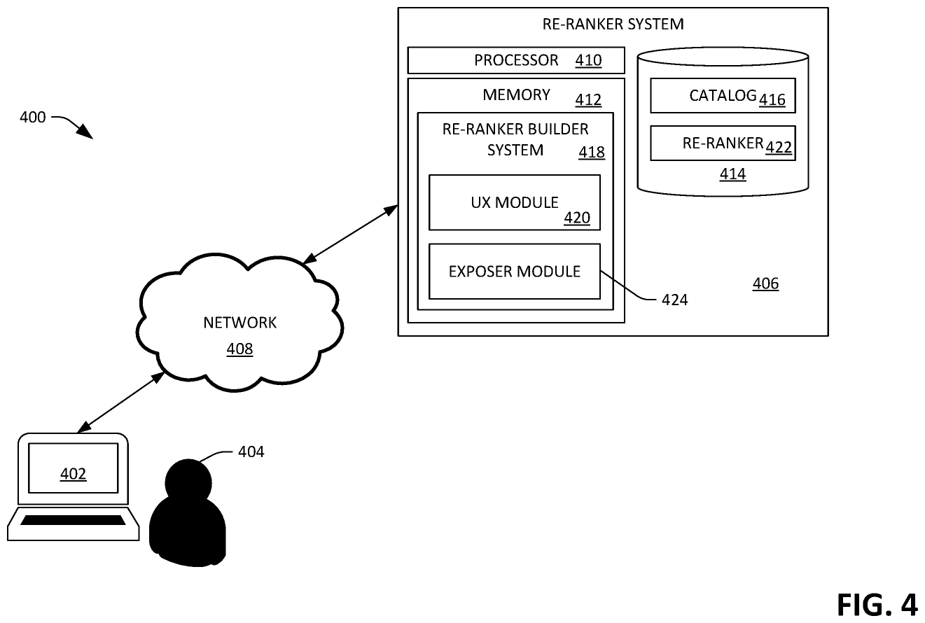

Now referring to FIG. 4, an exemplary system 400 is illustrated, wherein the system 400 is configured to construct a customized re-ranker based upon input received from a client computing device. The system 400 includes a client computing device 402 operated by a representative 404 of a company. The system 400 additionally includes a re-ranker system 406, wherein the client computing device 402 is in communication with the re-ranker system 406 by way of a network 408. The re-ranker system 406 includes a processor 410, memory 412, and a data store 414, The data store 414 includes an electronic catalog 416 for the company, wherein the catalog 416 comprises values that are representative of features of goods and/or services that are offered for acquisition by the company.

The memory 412 includes a re-ranker builder system 418 that is configured to construct and/or update a customized re-ranker for the company based upon input received from the client computing device 402. In an exemplary embodiment, the re-ranker builder system 418 includes a user experience (UX) module 420. The UX module 420 is configured, upon receipt of a request from the client computing device 402, to cause the client computing device 402 to present a graphical user interface (GUI) or sequence of GUIs for display on a display of the client computing device 402. The GUI or sequence of GUIs are configured to receive input from the representative 404 of the company, wherein such input is usable to define logic that is to be implemented in the re-ranker that is being designed. For instance, the GUI or sequence of GUIs can include interface elements that allow the representative 404 to define weights that are to be assigned to features of goods and/or services in the catalog 416. The GUI or sequence of GUIs can also include interface element(s) that allow the representative 404 to define a location (where the re-ranker is to be used to re-rank search results only when a query is submitted from a client computing device at the location). In yet another example, the GUI or sequence of GUIs can include interface element(s) that allow the representative to define a time window (where the re-ranker is to be used to re-rank search results only when a query is submitted within the time window).

The UX module 420 can access the catalog 416 and identify features of products and/or services represented by entries in the catalog 416 and provide interface element(s) that allow the representative 404 to set forth input as to how such features are to be weighted by the re-ranker that is being constructed. For instance, a GUI constructed by the UX module 420 can allow the representative 404 to identify a brand of a good, and to further indicate that search results that represent products of the brand are to be boosted. In another example, a feature in the catalog 416 may be “inventory” and the UX module 420 can cause a GUI to be constructed that allows the representative 404 to indicate that products with inventory below a threshold are to be boosted. Based upon the input received by way of the GUI or sequence of GUIs constructed by the UX module 420, the UX module 420 can construct a re-ranker 422 that is customized for the company and can further cause the re-ranker 422 to be stored in the data store 414. The re-ranker 422 may then be provided to the search system 124 for subsequent employment in connection with re-ranking search results.

The re-ranker builder system 418 may further include an exposer module 424 that is configured to expose an application programming interface (API) of the search module 132. In such an embodiment, the representative 404 can construct logic in a scripting language and present such logic to the re-ranker system 406 by way of the exposer module 424. The exposer module 424 receives the logic and constructs the re-ranker 422 based upon such logic. As the exposer module 424 directly exposes the API of the search module 132, the re-ranker 422 is able to be constructed and deployed relatively quickly. The UX module 420 is well-suited for representatives of companies who are somewhat novice programmers, while the exposer module 424 is configured for use by representatives of companies who are more advanced programmers.

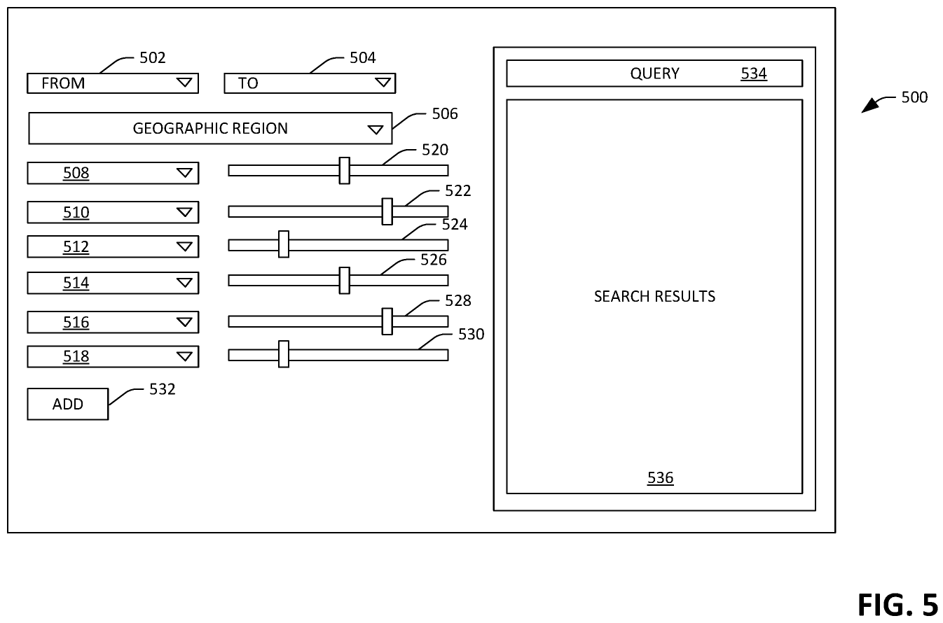

Now referring to FIG. 5, an exemplary graphical user interface 500 that can be constructed by the UX module 420 and presented on the display of the client computing device 402 is illustrated. The GUI 500 includes a plurality of selectable interface elements. For instance, the GUI 500 can include a first interface element 502 that is configured to allow the representative 404 to define a beginning of a time window, wherein a customized re-ranker generated through use of the GUI 500 is be used to re-rank search results when a query has a timestamp assigned thereto that is within the time window. A second interface element 504 is configured to receive input that defines an end of the aforementioned time window.

A third interface element 506 can receive input as to a geographic region that is to be associated with the re-ranker. Accordingly, the representative 404 can set forth input as to a country, a state, a city, etc., wherein the re-ranker created by way of the GUI 500 is to be employed to re-rank search results only when a client computing device that submits a query to a host system is within the geographic region. The GUI 500 also includes numerous drop-down elements 508-518 and sliders 520-530 that respectively correspond to the drop-down elements 508-518. Responsive to the representative 404 selecting a drop-down element (e.g., the drop-down element 508), a selectable list of features (retrieved from the electronic catalog of the company) can be presented, wherein the representative 404 can select a feature from the list of features. Exemplary features include, but are not limited to, brand, inventory level, price, etc. Once the feature has been selected from the list of selectable features, the slider 520 can be employed to define how the re-ranker is to weigh such feature when re-ranking search results. A default position of the slider 520 may be a central position, which indicates that the re-ranker is to neither boost nor decrement a search result in a ranked list of search results based upon the feature. Movement of slider 520 to the right results in greater weight being assigned to the feature (such that a search result having a certain value for the feature is boosted), while movement of the slider 520 to the left results in a lesser weight being assigned to the feature (such that a search result having a certain value for the feature is decremented). In the exemplary GUI 500 illustrated in FIG. 5, the representative 404 has selected six features of goods and/or services represented in the catalog 416 and identified how those features are to be considered by the re-ranker. The GUI 500 further includes a button 532 that, when selected by the representative 404, causes another drop-down element to be presented such that the representative 404 can set forth input as to another feature.

The GUI 500 further includes a query field 534 and a search results field 536. The query field 534 is configured to receive a query from the representative 404, and the representative 404 can input a query to the query field 534 that may be typical of a query set forth by an end-user who desires to search the catalog 416. The search results field 536 depicts search results that will be returned to the end-user when the search module 132 returns search results based upon the query, and further wherein the search module 132 includes a re-ranker that is defined based upon the input set forth by the representative 404 by way of the GUI 500. Based upon the query set forth in the query field 534, the search results field 536 can be updated in real-time to depict how movement of the slider(s) 520-530 would change the order of the search results. Hence, the representative 404 can ascertain the impact of the re-ranker that is being constructed via the GUI 500 as the positions of the sliders 520-530 are altered. For example, the representative 404 may wish to ensure that a certain good is topmost in a ranked list of search results based upon a query. The representative 404 can set forth the query in the query field 534 and review the search results depicted in the search results field 536. If the product is not at the top of the search results, the representative 404 can alter position of one or more sliders 520-530, change features being considered (e.g., add or remove features corresponding to the sliders 520-530), etc., until the representative 404 is provided with the desired result.

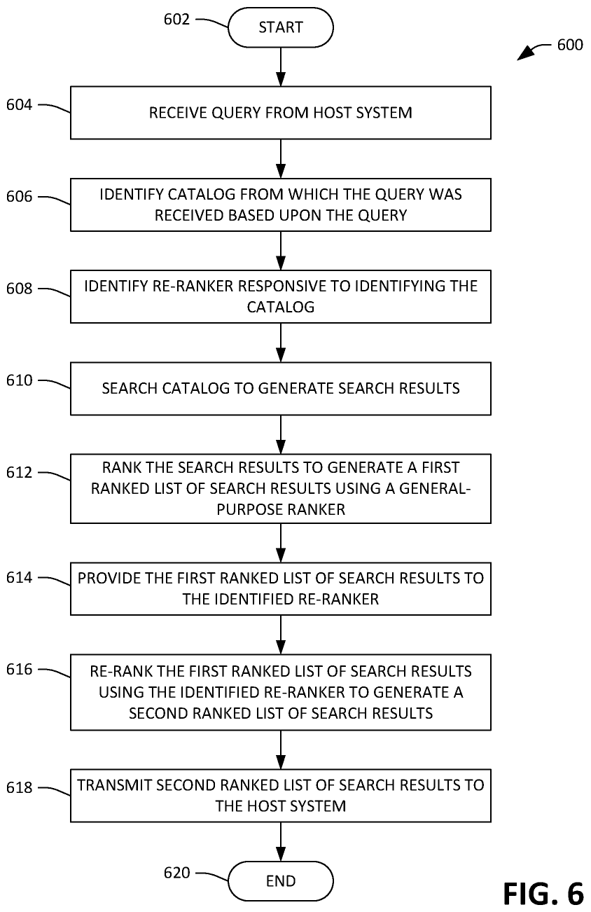

FIGS. 6-8 illustrate exemplary methodologies relating to using a customized re-ranker to re-rank a ranked list of search results returned by a general-purpose ranker. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

With reference now to FIG. 6, a flow diagram illustrating an exemplary methodology 600 for creating a ranked list of search results is illustrated. The methodology 600 starts at 602, and at 604 a query is received from a host system. The host system hosts content for a company that is offering goods and/or services for acquisition. While not illustrated in the methodology 600, the host system previously received the query from a client computing device operated by a user who provided the query to the client computing device (e.g., the user is looking to obtain information about one or more of the goods and/or services available for acquisition from the company).

At 606, responsive to receiving the query, a catalog that is to be searched based upon the query is identified, wherein the catalog is an electronic catalog of goods and/or services that are offered for acquisition from a particular company. For example, the query can have a URL that identifies the host system, and thus identifies the company, and hence identifies the catalog that is to be searched based upon the query.

At 608, a customized re-ranker that is to be used to re-rank search results is identified based upon the URL. In addition, the customized re-ranker can be identified based upon other factors, including a feature of the query (e.g., time that the query was submitted), a feature of a product or service represented in the catalog (e.g., an amount of inventory of a product in the catalog). At 610, the company catalog is searched to generate search results, wherein each search result in the search results is identified as being at least somewhat relevant to the query. At 612, a general-purpose ranker is used to generate a first ranked list of search results. Put differently, the search results generated at 610 are ranked using a general-purpose ranker, wherein the general-purpose ranker is employed regardless of the catalog being searched.

At 614, the first ranked list of search results generated at 612 is provided to the customized re-ranker identified at 608. At 616, the first ranked list of search results is re-ranked using the identified re-ranker to generate a second ranked list of search results. At 618, the second ranked list of search results is transmitted to the host system, whereupon the host system can incorporate the second ranked list of search results into an application page or webpage, and further whereupon the host system can transmit the application page or webpage with the second ranked list of search results incorporated therein to the client computing device from which the host system receive the query. The methodology 600 completes at 620.

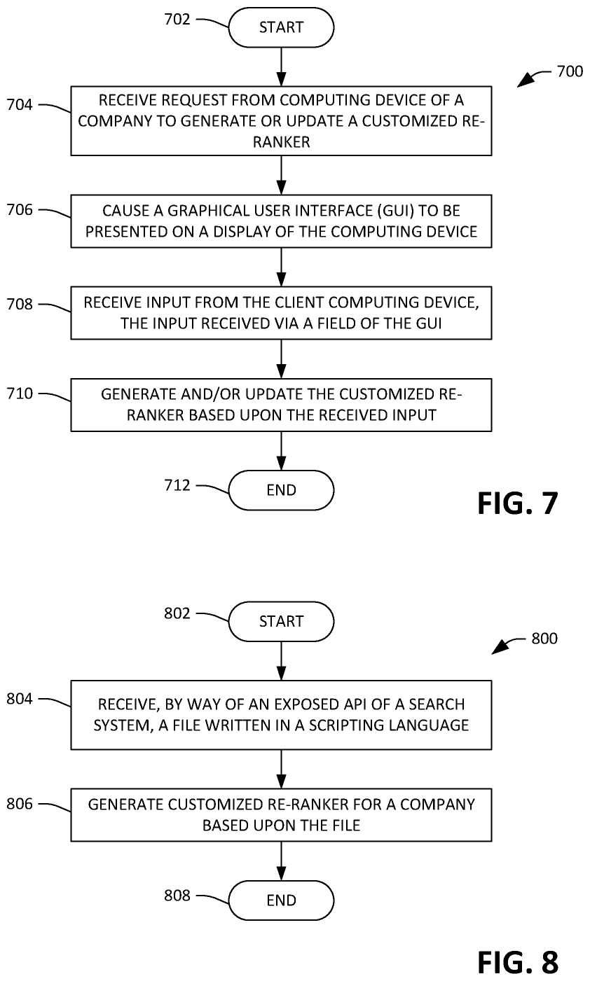

With reference now to FIG. 7, an exemplary methodology 700 for generating a customized re-ranker is illustrated. The methodology 700 starts at 702, and at 704 a request is received from a client computing device of a company, wherein the request is to generate or update a customized re-ranker for the company, and further wherein the client computing device of the company is operated by a representative of the company. At 706, a graphical user interface is caused to be presented on a display of the client computing device, and at 708 input is received from the client computing device by way of a field of the graphical user interface. Exemplary inputs that can be received at the graphical user interface have been illustrated and described with respect to FIG. 5. At 710, a customized re-ranker is generated and/or updated based upon the input received at 708, whereupon the customized re-ranker can be used to re-rank search ranked lists of search results output by a general-purpose ranker. The methodology 700 completes at 712.

Now referring to FIG. 8, a flow diagram illustrating another exemplary methodology 800 for generating and/or updating a customized re-ranker is illustrated. The methodology 800 starts at 802, and at 804 a file written in a scripting language is received by way of an exposed API of the search module 132. At 806, the customized re-ranker is generated and/or up updated based upon the file received at 804. The methodology 800 completes at 808.

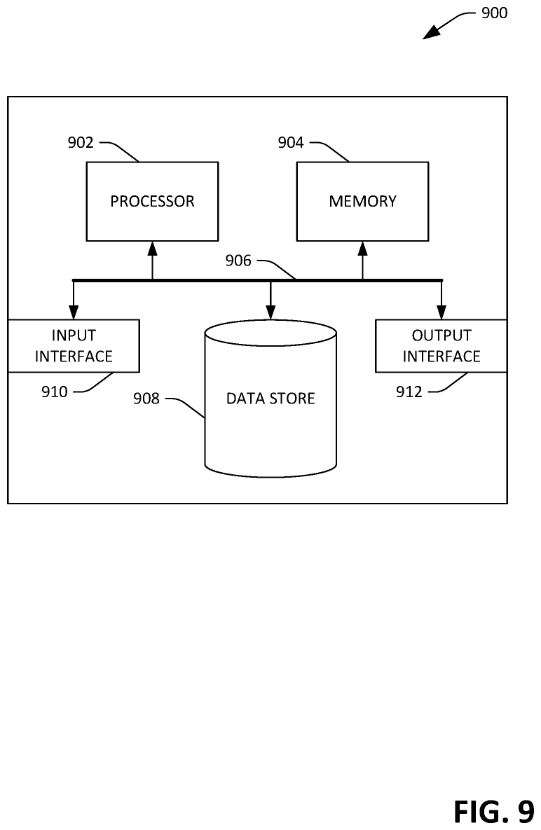

Referring now to FIG. 9, a high-level illustration of an exemplary computing device 900 that can be used in accordance with the systems and methodologies disclosed herein is illustrated. For instance, the computing device 900 may be used in a system that supports searching catalogs and ranking search results through use of a customized re-ranker. By way of another example, the computing device 900 can be used in a system that supports building and/or updating a customized re-ranker. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store electronic catalogs, re-rankers, etc,

The computing device 900 additionally includes a data store 908 that is accessible by the processor 902 by way of the system bus 906. The data store 908 may include executable instructions, electronic catalogs, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, RUM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A search system comprising:
at least one processor; and
memory storing instructions that, when executed by the at least one processor, cause the at least one processor to perform acts comprising:
receiving a query from a server computing device that hosts content for a company that is offering goods for acquisition, wherein the query was received by the server computing device from a client computing device operated by a user who provided the query to the client computing device;
responsive to receiving the query, accessing a catalog that is assigned to the company, wherein the catalog is accessed from amongst a plurality of catalogs, and further wherein the catalog comprises values that represent features of the goods;
based upon the query and the values that represent the features of the goods, generating a ranked list of search results, wherein the ranked list of search results represent a subset of the goods, and further wherein the ranked list of search results is generated by a computer-implemented ranker that is employed to generate ranked lists of search results for a plurality of companies regardless of which of the plurality of catalogs is searched;
responsive to generating the ranked list of search results, re-ranking the ranked list of search results to generate a second ranked list of search results, wherein the ranked list of search results is re-ranked using a re-ranker that is customized for the company; and
transmitting the second ranked list of search results to the server computing device, wherein the server computing device, in response to receiving the second ranked list of search results, transmits the second ranked list of search results to the client computing device for presentment to the user.

2. The search system of claim 1, further comprising:
prior to receiving the query from the server computing device, receiving input from a second client computing device operated by a user of the company, wherein the input is configured to customize the re-ranker; and
customizing the re-ranker based upon the input.

3. The search system of claim 2, wherein the input comprises a file written in a scripting language.

4. The search system of claim 2, the acts further comprising:
prior to receiving the input, receiving a request from the second client computing device to provide the input to the search system;
responsive to receiving the request, causing a graphical user interface to be presented on a display of the second client computing device, the graphical user interface comprising a field that is configured to receive the input; and
receiving the input from the second client computing device based upon the input being provided in the field of the graphical user interface.

5. The search system of claim 1, wherein the re-ranker has a geographic region assigned thereto, wherein the query has location data assigned thereto that indicates that the client computing device is within the geographic region, the acts further comprising:
responsive to receiving the query, determining that the client computing device is within the geographic region assigned to the re-ranker based upon the location data assigned to the query; and
selecting the re-ranker from amongst a plurality of re-rankers responsive to determining that the client computing device is within the geographic region assigned to the re-ranker.

6. The search system of claim 1, wherein the re-ranker has a time window assigned thereto, wherein the query has a timestamp assigned thereto that indicates that the client computing device received the query within the time window assigned to the re-ranker, the acts further comprising:
responsive to receiving the query, determining that the query was received within the time window assigned to the re-ranker based upon the timestamp assigned to the query; and
selecting the re-ranker from amongst a plurality of re-rankers responsive to determining that the query was received within the time window assigned to the re-ranker.

7. The search system of claim 1, wherein the query has a feature, the acts further comprising:
responsive to receiving the query, selecting the re-ranker from amongst a plurality of re-rankers that are customized for the company based upon the feature of the query.

8. The search system of claim 1, wherein the re-ranker is customized to boost search results that represent goods that have a specified value for a feature of the goods.

9. A method performed by a search system, the method comprising:
generating a ranked list of search results based upon a query received from a server computing device that is in network communication with the search system, wherein the search system searches a catalog that is assigned to the company to generate the ranked list of search results, wherein the catalog comprises entries that represent goods that are available for acquisition from the company, and further wherein the server computing device received the query from a client computing device that is operated by a user who provided the client computing device with the query;
providing the ranked list of search results to a computer-implemented re-ranker, wherein the computer-implemented re-ranker is customized for the company based upon input received by the search system from a second client computing device that is operated by a representative of the company;
using the computer-implemented re-ranker, re-ranking the ranked list of search results to generate a second ranked list of search results, wherein the ranked list of search results and the second ranked list of search results comprise a subset of goods represented in the catalog; and
transmitting the second ranked list of search results to the server computing device, wherein the server computing device causes the second ranked list of search results to be presented on a display of the client computing device from which the query was received.

10. The method of claim 9, wherein the server computing device is a web server that hosts a website of the company.

11. The method of claim 9, wherein the server computing device is an application server that hosts an application for the company, wherein the application is a mobile application, and further wherein the client computing device is a mobile telephone.

12. The method of claim 9, further comprising:
prior to generating the ranked list of search results, receiving the input from the second client computing device operated by the representative of the company; and
responsive to receiving the input and based upon the input, constructing the re-ranker.

13. The method of claim 12, wherein the input comprises a file written in a scripting language.

14. The method of claim 12, further comprising:
prior to receiving the input, receiving a request from the second client computing device to provide the input to the search system;
responsive to receiving the request, causing a graphical user interface to be presented on a display of the second client computing device, the graphical user interface comprising a field that is configured to receive the input; and
receiving the input from the second client computing device based upon the input being provided in the field of the graphical user interface.

15. The method of claim 9, wherein the re-ranker has a geographic region assigned thereto, wherein the query has location data assigned thereto that indicates that the client computing device is within the geographic region, the method further comprising:
determining that the client computing device is within the geographic region assigned to the re-ranker based upon the location data assigned to the query; and
causing the re-ranker to re-rank the ranked list of search results to generate the second ranked list of search results responsive to determining that the client computing device is within the geographic region assigned to the re-ranker.

16. The method of claim 9, wherein the re-ranker has a time window assigned thereto, wherein the query has a timestamp assigned thereto that indicates that the client computing device received the query within the time window assigned to the re-ranker, the acts further comprising:
determining that the query was received within the time window assigned to the re-ranker based upon the timestamp assigned to the query; and
causing the re-ranker to re-rank the ranked list of search results to generate the second ranked list of search results responsive to determining that the query was received within the time window assigned to the re-ranker.

17. A computer-readable storage medium of a search system, the computer-readable storage medium comprising instructions that, when executed by a processor, cause the processor to perform acts comprising:
generating a ranked list of search results based upon a query received from a server computing device that is in network communication with the search system, wherein the search system searches a catalog that is assigned to the company to generate the ranked list of search results, wherein the catalog comprises entries that represent goods that are available for acquisition from the company, and further wherein the server computing device received the query from a client computing device that is operated by a user who provided the client computing device with the query;
providing the ranked list of search results to a computer-implemented re-ranker, wherein the computer-implemented re-ranker is customized for the company based upon input received by the search system from a second client computing device that is operated by a representative of the company;
using the computer-implemented re-ranker, re-ranking the ranked list of search results to generate a second ranked list of search results, wherein the ranked list of search results and the second ranked list of search results comprise a subset of search results from the catalog; and
transmitting the second ranked list of search results to the server computing device, wherein the server computing device causes the second ranked list of search results to be presented on a display of the client computing device from which the query was received.

18. The computer-readable storage medium of claim 17, wherein the re-ranker is selected from amongst a plurality of re-rankers that are assigned to the company, wherein the re-ranker is selected based upon a feature of the query.

19. The computer-readable storage medium of claim 17, wherein the catalog comprises data that indicates that inventory of a good of the company is above a threshold, the acts further comprising:
determining that the ranked list of search results includes a search result that represents the good;
responsive to determining that the ranked list of search results includes the search result that represents the good, determining that the inventory of the good is above the threshold; and
causing the re-ranker to re-rank the ranked list of search results to generate the second ranked list of search results responsive to determining that the inventory of the good is above the threshold.

20. The computer-readable storage medium of claim 17, wherein the catalog comprises data that indicates that inventory of a good of the company is below a threshold, the acts further comprising:
determining that the ranked list of search results includes a search result that represents the good;
responsive to determining that the ranked list of search results includes the search result that represents the good, determining that the inventory of the good is below the threshold; and
causing the re-ranker to re-rank the ranked list of search results to generate the second ranked list of search results responsive to determining that the inventory of the good is below the threshold.
